(19) United States
(12) Patent Application Publication
(10) Pub. No.: US 2021/0068929 A1
(43) Pub. Date: Mar. 11, 2021

(54) Orthodontic Appliance with Increased Torsional Control

(71) Applicant: Ortho Mogul, LLC, San Antonio, TX (US)

(72) Inventor: Robert Norris, San Antonio, TX (US)

(21) Appl. No.: 17/013,204

(22) Filed: Sep. 4, 2020

Related U.S. Application Data
(60) Provisional application No. 62/896,539, filed on Sep. 5, 2019.

(51) Int. Cl. A61C 7/28; A61C 7/36

(52) U.S. Cl. CPC A61C 7/28; A61C 7/36; A61C 7/287

(57) ABSTRACT

An orthodontic appliance, orthodontic brackets and orthodontic methods are provided. An orthodontic appliance can include a plurality of orthodontic brackets. Each orthodontic bracket of the orthodontic appliance can include a bracket base for bonding the orthodontic bracket to a respective tooth and a bracket body extending from the bracket base. The bracket body can define an archwire slot having 0.020-inch slot height and 0.026-inch slot depth and adapted to retain an archwire having a 0.019-inch wire height and a 0.025-inch wire depth. The plurality of orthodontic brackets can include a first orthodontic bracket and second orthodontic bracket. The first orthodontic bracket can be installable on either a left side of an oral cavity or a right side of the oral cavity on the same row of teeth. The second orthodontic bracket can be substantially identical to the first orthodontic bracket.

### RELATED APPLICATIONS

This application claims the benefit of priority under 35 U.S.C. § 119(e) to U.S. Provisional Patent Application No. 62/896,539, entitled “Orthodontic Bracket Prescription and Versatile Orthodontic Brackets,” filed Sep. 5, 2019, which is hereby fully incorporated herein by reference.

### BACKGROUND

Patients seeking orthodontic treatment are for the most part primarily concerned with the presence of crooked teeth, primarily in the front area of the mouth. Among the chief complaints are dental crowding, flaring, irregularity in tooth alignment, unpleasing tooth appearance, “gummy” smile, and difficulty in chewing, among other issues. These issues are commonly solved through the use of braces.

There are traditionally four basic elements used in conventional orthodontics: brackets, bonding material, archwire, and ligature elastic. The brackets are small attachments affixed to the patient's teeth using the bonding material so that the archwire can be placed in the slots of the brackets. The archwire is the wire that connects the brackets and guides the teeth. The teeth move when the archwire puts pressure on the brackets and teeth. Elastic ligature ties (O-rings) are small elastic bands that help hold the archwire into the slot of the bracket. As will be appreciated, steel ligature ties can also be used. Alternatively, a mechanical clasp or door can be incorporated into the design of the bracket to secure the archwire into place—this style of bracket is referred to as self-ligating. The brackets may incorporate hooks that allow elastics (e.g., rubber bands) to be attached between the upper and lower jaw to put force on the jaw and help align the upper and lower teeth. Other components may be used to put force on the teeth in specific directions. For example, springs may be placed between brackets to push teeth apart. As another example, a power chain—that is a connected row of elastic loops or ligatures—may be used to pull several teeth together.

Historically, orthodontic brackets have used one of two slot heights: 0.018 inch and 0.022 inch. For over 100 years, commercially available orthodontic brackets have been available in an 0.022×0.028-inch slot size. Brackets with a 0.018-inch slot height enjoyed brief popularity in the 1970s and 1980s but have since waned in both popularity and availability due to the limitation of only being able to utilize a maximum wire dimension of 0.017×0.025 inch, which does not provide enough force for certain tooth movements such as deep bite correction. Today, less than 10% of orthodontic brackets sold are of 0.018-inch slot height; whereas the remaining 90% or more of bracket sales have a 0.022-inch slot height dimension.

The 0.022×0.028-inch slot size served the profession well when highly malleable gold alloy wires were used, as the softer material could be fabricated in an 0.021×0.025-inch dimension, providing complete engagement between the wire and the bracket. However, with the advent of newer wire materials such as Stainless Steel, Titanium-Molybdenum Alloy, and Nickel-Titanium Alloy, wires of 0.021×0.025 inch are too stiff and provide too much force to the teeth, leading to bracket adhesion failures, pain to the patient, and higher risk of root resorption. Therefore, less than 1% of orthodontic wires sold are 0.021×0.025 inch in dimension. Instead, 019×0.025-inch wires are overwhelmingly used. This leaves a gap or “slop” between the wire and the bracket slot prescription, such that accurate 3-dimensional control of the teeth is challenging.

For example, a recent study calculated this torsional play to be 13-30 degrees in both the clockwise and counterclockwise direction, depending on the brand of wire and brand of bracket, due to differing manufacturer's tolerances. This means that there is 26-60 degrees of total play in between the 0.022-inch slot height brackets and the 0.019-inch wires tested. Even at the smallest end of the spectrum, this is an enormous amount of play and demonstrates the lack of torsional control that a 0.019-inch height wire exerts in a 0.022-inch slot height bracket. Thus, despite the need for an orthodontic appliance capable of producing mechanical properties suited to finishing treatment and additionally exhibiting torsion control, orthodontists continue to use appliances with slot heights that produce non-ideal properties.

There is therefore a need for improved orthodontic appliances capable of producing mechanical properties suited to finishing treatment and additionally exhibiting improved torsion control.

### SUMMARY

As will be appreciated, the “prescription” of an orthodontic bracket archwire slot is defined by the slot dimension as well as the slot orientation relative to the bracket base (the part of the bracket which is adhered to the tooth) in three dimensions, commonly expressed as: 1. Tip, 2. Torque, and 3. Rotation. Tip, torque, and rotation are generally expressed as angles. The prescription may also include an in/out dimension expressed as a distance. Each tooth has a unique orthodontic prescription and the sum of the twenty-eight individual prescriptions (one for each of the 28 teeth) defines an overall bracket appliance prescription.

Embodiments described herein include a prescription (a “20/26 prescription”) that solves the problem of excessive play between the bracket and the wire encountered in the currently available 0.022″×0.02× prescriptions (0.02× is used to describe the bracket slot depth, as there some variability between manufacturers) by offering a bracket slot dimension of 0.020×0.026 inch, which allows a wire of 0.019×0.025 inch to fully express the 20/26 prescription due to the intimate fit of wire and bracket.

In some embodiments, a prescription (e.g., a 20/26 prescription) may use brackets of the same design on multiple teeth. For example the same bracket design may be used for the upper left cuspid and lower right cuspid; the same bracket design may be used for the upper right cuspid and lower left cuspid; the same bracket design may be used for the upper first premolar and upper second premolar brackets and the same bracket design may be used for the right premolar brackets can be used on the left—other words, a universal premolar bracket can be provided which will fit all maxillary premolars; the same bracket design may be used for the lower first premolar and lower second premolar brackets and the same bracket design used for the right premolar brackets can be used on the left—in other words, a universal premolar bracket can be provided that will fit all mandibular premolars.

One general aspect includes an orthodontic appliance that includes a plurality of orthodontic brackets. An orthodontic bracket may include: a bracket base for bonding the orthodontic bracket to a respective tooth and a bracket body extending from the bracket base. The bracket body may define an archwire slot having a 0.020-inch slot height and 0.026-inch slot depth. The archwire slot can be adapted to retain an archwire having a 0.019-inch wire height and a 0.025-inch wire depth. The plurality of orthodontic brackets includes a first orthodontic bracket and second orthodontic bracket. The first orthodontic bracket may be installable according to a prescription on either a left side of an oral cavity or a right side of the oral cavity on a first row of teeth—that is, the first orthodontic bracket is equally adapted for being installed on the right side of the oral cavity as the left side of the oral cavity on the same row of teeth. The second orthodontic bracket may be substantially identical to the first orthodontic bracket.

Implementations may include one or more of the following features. The orthodontic brackets may have a total torsional play of less than twenty-six degrees. An orthodontic bracket may include a ligating slide, the ligating slide movable from an open position to a closed position to retain the archwire in the archwire slot of the orthodontic bracket. The ligating slide may include a front surface, a rear surface, and a leading edge having a curved wire pushing portion. The leading edge may be curved from the rear surface to the front surface. The archwire may have a rectangular cross-section with rounded corners.

Implementations may also include one or more of the following features. The first orthodontic bracket and the second orthodontic bracket each may include a universal gingival hook. The first orthodontic bracket and the second orthodontic bracket may be universal maxillary premolar brackets. In another embodiment, the first orthodontic bracket and the second orthodontic bracket may be universal mandibular premolar brackets.

According to some embodiments, the bracket body of the first orthodontic bracket may include: a mesial gingival tie wing; a distal gingival tie wing; and a gingival wall extending between the mesial gingival tie wing the distal gingival tie wing. A universal gingival hook may extend from the gingival wall between the mesial gingival tie wing and the distal gingival tie wing.

In some implementations, the plurality of orthodontic brackets includes a third orthodontic bracket for installation on the first row of teeth and a fourth orthodontic bracket for installation on the first row of teeth, the third orthodontic bracket and the fourth orthodontic bracket being substantially identical to the first orthodontic bracket and the second orthodontic bracket. The first orthodontic bracket, the second orthodontic bracket, the third orthodontic bracket and the fourth orthodontic bracket may be premolar brackets.

In some implementations, the plurality of orthodontic brackets includes a third orthodontic bracket for installation on the left side of the oral cavity on the first row of teeth and a fourth orthodontic bracket for installation on the right side of the oral cavity on a second row of teeth, the third orthodontic bracket and the fourth orthodontic bracket being substantially identical. According to one embodiment, third orthodontic bracket and the fourth orthodontic bracket are cuspid brackets.

Another general aspect includes an orthodontic bracket. The orthodontic bracket includes a bracket base for bonding the orthodontic bracket to a respective tooth. The bracket also includes a bracket body extending from the bracket base, the bracket body may define an archwire slot having 0.020-inch slot height and 0.026-inch slot depth. The archwire slot may be adapted to retain an archwire having a 0.019-inch wire height and a 0.025-inch wire depth. According to one embodiment, the orthodontic bracket is installable according to a prescription on either a left side of an oral cavity or a right side of the oral cavity on the same row of teeth—that is, the orthodontic bracket is equally adapted for being installed on the right side of the oral cavity as the left side of the oral cavity on the same row of teeth.

Implementations may include one or more of the following features. The orthodontic bracket where the orthodontic bracket has a total torsional play of less than twenty-six degrees. The orthodontic bracket may include a ligating slide movable from an open position to a closed position to retain the archwire in the archwire slot, the ligating slide may include a front surface, a rear surface, and a leading edge having a curved wire pushing portion. The bracket body may include: a mesial gingival tie wing; a distal gingival tie wing; a gingival wall extending between the mesial gingival tie wing the distal gingival tie wing; and a universal gingival hook extending from the gingival wall between the mesial gingival tie wing and the distal gingival tie wing.

Other general aspects include methods that comprise providing orthodontic appliances or orthodontic brackets and installing the orthodontic appliance or brackets. One embodiment, for example, includes providing an orthodontic appliance that includes a plurality of orthodontic brackets. The orthodontic brackets may include: a bracket base for bonding the orthodontic bracket to a respective tooth and a bracket body extending from the bracket base. The bracket body may define an archwire slot having a 0.020-inch slot height and 0.026-inch slot depth. The archwire slot can be adapted to retain an archwire having a 0.019-inch wire height and a 0.025-inch wire depth. The plurality of orthodontic brackets may include a first orthodontic bracket and second orthodontic bracket. The first orthodontic bracket may be installable according to a prescription on either a left side of an oral cavity or a right side of the oral cavity on a first row of teeth. The method can further include installing the orthodontic appliance. The method may further include using the orthodontic appliance to move the patient's teeth.

These, and other, aspects of the disclosure will be better appreciated and understood when considered in conjunction with the following description and the accompanying drawings. It should be understood, however, that the following description, while indicating various embodiments of the disclosure and numerous specific details thereof, is given by way of illustration and not of limitation. Many substitutions, modifications, additions, or rearrangements may be made within the scope of the disclosure without departing from the spirit thereof, and the disclosure includes all such substitutions, modifications, additions, or rearrangements.

### BRIEF DESCRIPTION OF THE DRAWINGS

The drawings accompanying and forming part of this specification are included to depict certain aspects of the disclosure. It should be noted that the features illustrated in the drawings are not necessarily drawn to scale. A more complete understanding of the disclosure and the advantages thereof may be acquired by referring to the following description, taken in conjunction with the accompanying drawings in which like reference numbers indicate like features and wherein:

FIG. 1A and FIG. 1B illustrate the upper and lower teeth of a patient undergoing orthodontic therapy. FIG. 1C illustrates one embodiment of a subset of the upper and lower brackets, from first molar to first molar, excluding second molars, that may be used in orthodontic treatment.

FIG. 2A is a perspective view of a self-ligating premolar bracket according to one embodiment.

FIG. 2B is a gingival view of a self-ligating premolar bracket according to one embodiment. FIG. 2C is an occlusal end view of a self-ligating premolar bracket according to one embodiment. FIG. 2D is a front view of a self-ligating premolar bracket according to one embodiment. FIG. 2E is a side view of a self-ligating premolar bracket according to one embodiment. FIG. 2F is a cross-sectional view of a self-ligating premolar bracket according to one embodiment. FIG. 2G is a cross-sectional view of a self-ligating premolar bracket with an archwire installed according to one embodiment. FIG. 2H illustrates one embodiment of closing a ligating slide according to one embodiment.

FIG. 3A is a perspective view of another embodiment of a self-ligating premolar bracket and FIG. 3B is a side view of a self-ligating premolar bracket according to an embodiment.

FIG. 4A is a perspective view of a cuspid bracket according to one embodiment. FIG. 4B is a front view of a cuspid bracket according to one embodiment. FIG. 4C is a cross-sectional view of a cuspid bracket according to one embodiment.

FIG. 5 is a perspective view of a first molar bracket according to one embodiment.

FIG. 6 is a perspective view of an incisor bracket according to one embodiment.

FIG. 7 illustrates one embodiment of 20/26 prescription.

### DETAILED DESCRIPTION

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure the embodiments in detail. It should be understood, however, that the detailed description and the specific examples are given by way of illustration only and not by way of limitation. Various substitutions, modifications, additions and/or rearrangements within the spirit and/or scope of the underlying inventive concept will become apparent to those skilled in the art from this disclosure.

As discussed above, studies have calculated that the torsional play between an archwire having 0.019-inch height and bracket with a 0.022-inch slot height to be 13-30 degrees in both the clockwise and counterclockwise direction, leading to a total play of 26-60 degrees of total play between the 0.022-inch slot brackets and the 0.019-inch wires tested.

Torque moments are measured using a mechanical force testing system, which twists straight pieces of stainless-steel wire seated in the bracket being tested in increments of 0.5 inch until a full torsional expression is registered. This test yields both the torsional play and total play of the tested bracket. The test uses the Force System Identification machine developed for the Section of Orthodontics of the Institute of Odontology, Aarhus University (Melsen et al., 1992). Movements of the sensors are generated by six computer-controlled incremental motors and occur stepwise with a minimal increment of 0.1 mm for translation and 0.15° for rotation. The sensors are initially positioned in a predetermined position, which are stored in a connected computer and used as the zero-position throughout the total experiment. The movement of the sensors to the desired location is controlled by the computer and carried out by the step-motors. Sixteen strain-gauges inside the sensors measure deformations, which are amplified, converted into digital signals, and calibrated to forces and moments and the computer then records and stores these data. The three planes of space are represented by the x-, y- and z-axes. They are illustrated as an orthogonal right-handed coordinate system at the two sensors. The forces and moments can therefore have a positive or negative sign. The reproducibility of the system has been previously reported and was found to be within plus/minus 5%.

Brackets are glued onto an aluminum bar in a row of ten (five brackets from the same system). Every slot is perpendicular to the long axis of the aluminum rod. This rod is fixed to the grips, allowing one bracket to be tested at a time. The rod with the brackets is attached to one of the sensors and either a rectangular 0.017×0.022-inch (for testing 0.018-inch brackets) or a 0.019×0.025-inch straight stainless steel archwire (for testing 0.022-inch brackets) is fixed to the rotating sensor on the opposite side and guided passively into the bracket slot. In the case of self-ligating brackets, the lock or clip was is closed and for conventional brackets the ligation is performed in a standardized way with 0.008-inch stainless steel ligatures tied tightly, while the wire is pressed onto the bottom of the bracket with an instrument as done in clinical practice. Measurements of the torqueing moments and the corresponding torqueing angles are carried out while the wire is being twisted in the bracket slot. The machine measures by twisting the wire in steps of 0.5 inch up until full moment expression is achieved (i.e. the moment vs. torsional angle curve had reached its maximal slope). The torqueing wire is then returned to its zero position and the test is repeated in the opposite direction to ensure full torsional expression of the wire in the slot in both directions. Torsional play is defined as the width of the flatter part of the curve, before full expression of the torqueing moment is reached. Especially for the brackets with conventional ligation, but also for some of the active self-ligating brackets, some build-up of torqueing moment will be observed before the full torsional moment expression is reached. The amount of this moment is divided by the amount of play of the corresponding bracket to calculate the amount of ‘residual’ stiffness (RS) in the play region. Moment—torque angle curves are constructed and are normalized by placing the origin at the middle of the play region, both to compensate for asymmetric bracket shape in the torqueing plane and to be able to make a comparison between the different brands of brackets. The measurements are carried out on five brackets from each of the 32 different bracket systems to evaluate the Ultra-bracket variation. The torque wire is never twisted to plastic deformation, or such that notching of the wire could give rise to scratches, which is checked by visual and tactile inspection. This test and an application of the test is detailed completely in Dalstra et al., Actual Versus Theoretical Torsional Play in Conventional and Self-Ligating Bracket Systems, Journal of Orthodontics, Vol. 0, 2015, 1-11.

Despite the availability of data from, for example, the test mentioned above, which shows the need for an orthodontic appliance capable of producing mechanical properties suited to finishing treatment and additionally exhibiting torsion control, orthodontists continue to use appliances with slot dimensions that produce non-ideal properties.

Embodiments of the present disclosure provide both torsion control and mechanical properties suited to the working and finishing stages of orthodontic treatment. According to one aspect, the brackets include slots or openings that accurately fit the wires most commonly used in orthodontic practices is provided. For example, one embodiment can comprise a bracket with a slot height of 0.020 inch, resulting in much improved torsional control when coupled with the overwhelming commonly used 0.019-inch height wire. In another embodiment of the present disclosure, an orthodontic system comprises an archwire having an archwire height and a bracket having a slot height, wherein the difference between the slot height and the archwire height is 0.001 inch.

More particularly, embodiments comprise a bracket with a slot height of 0.020 inch and a slot depth of 0.026 inch (a 0.020″×0.026″ slot size), resulting in much improved torsional control when coupled with 0.019×0.025-inch wire (a 0.019″×0.025″ wire). In another embodiment of the present disclosure, an orthodontic system comprises an archwire having an archwire height and an archwire depth and a bracket having a slot height and a slot depth, wherein the difference between the slot height and the archwire height is 0.001 inch and the difference between the archwire depth and the slot depth is 0.001 inch.

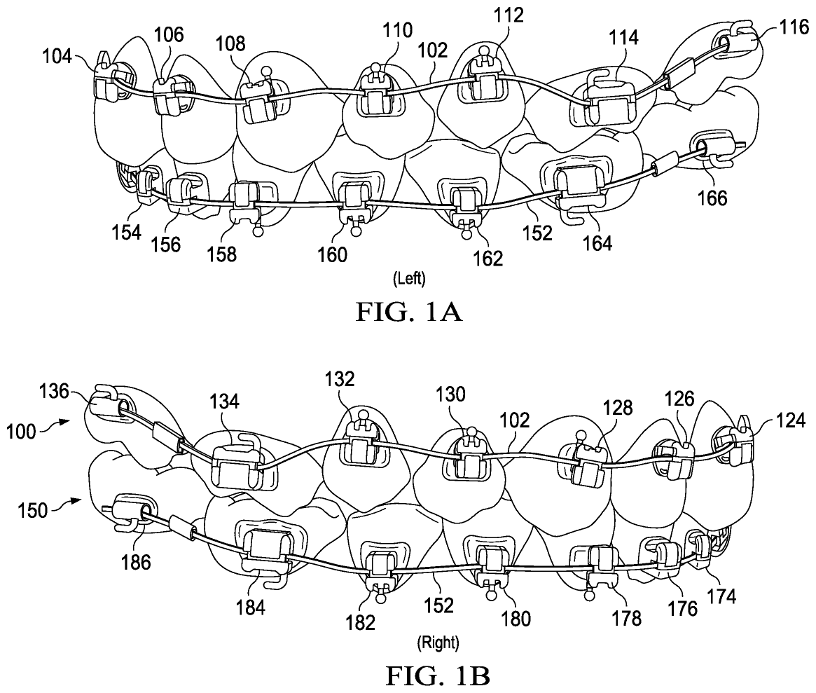

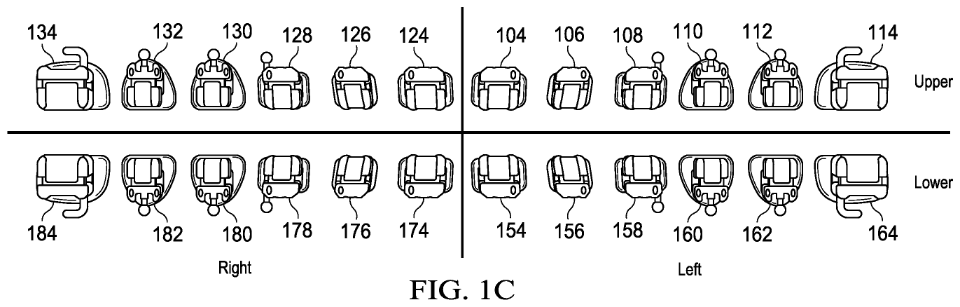

FIG. 1A and FIG. 1B illustrate the upper and lower teeth of a patient undergoing orthodontic therapy. FIG. 1C illustrates one embodiment of a subset of the upper and lower brackets, from first molar to first molar, excluding second molars, that may be used in orthodontic treatment. The patient has a first orthodontic appliance 100 (first braces) affixed to the upper teeth and a second orthodontic appliance 150 (second braces) affixed to the lower teeth. Each orthodontic appliance 100, 150 includes a set of brackets along with an archwire that is received in the slots or openings of the brackets.

First orthodontic appliance 100 comprises an archwire 102 received in central incisor brackets 104, 124, lateral incisor brackets 106, 126, cuspid brackets 108, 128, first premolar brackets 110, 130, second premolar brackets 112, 132, first molar brackets 114, 134 and second molar brackets 116, 136. Lower orthodontic appliance 150 comprises an archwire 152 received by central incisor brackets 154, 174, lateral incisor brackets 156, 176, cuspid brackets 158, 178, first premolar brackets 160, 180, second premolar brackets 162, 182, first molar brackets 164, 184 and second molar brackets 166, 186. Optionally, one or more of the brackets described above may be omitted in accordance with the preference of the orthodontist. For example, the patient may lack one or more of the illustrated teeth, if some of the permanent teeth have not yet erupted or one or more teeth may have been removed prior to orthodontic. The brackets may be formed of any suitable materials, such as, but not limited to, various ceramic and composite formulations and metal alloys, including, but not limited to cobalt chromium alloys.

The archwires 102, 152 may be formed of any suitable material, for example, metallic materials such as alloys of nitinol and stainless steel, beta titanium or other metallic materials. The size and material of the archwire may vary with the phase of treatment. One example an archwire sequence includes using 0.014 inch diameter archwire for initial alignment, a 0.018×0.018 inch NiTi archwire for working alignment, a 0.019×0.025 inch NiTi archwire for a first phase of working finishing and a 0.019×0.025 inch beta titanium archwire for a second phase of working finishing. According to one embodiment, one or more of the archwires in the archwire sequence (for example the archwires for the working phases) have a rectangular profile with rounded corners.

In general, each bracket can include a base for bonding the bracket directly to the enamel of a respective tooth by use of an adhesive. According to one embodiment, the base of each bracket has a concave contour that approximately matches the convex contour of the tooth surface. The base may be provided with grooves, particles, recesses, undercuts, a chemical bond enhancement material or any other material or structure or any combination of the foregoing that facilitates bonding the appliance directly to the tooth surface.

A bracket body extends from the base and defines a slot to receive the archwire. In particular embodiments, the brackets include 0.020″×0.026″ slots. In some embodiments, second molar brackets 116, 136,166, 186 are brackets known as buccal tubes, where the buccal tube has an opening shaped and size so that the archwire can be inserted. For example, the buccal tubes may have a 0.020″×0.026″ opening or slot. Moreover, each bracket may be designed to achieve a prescribed torque, tip, rotation and in/out. The brackets may also include various features such as tie wings for ligatures and power chains and hooks for elastics. One or more of the brackets may be self-ligating.

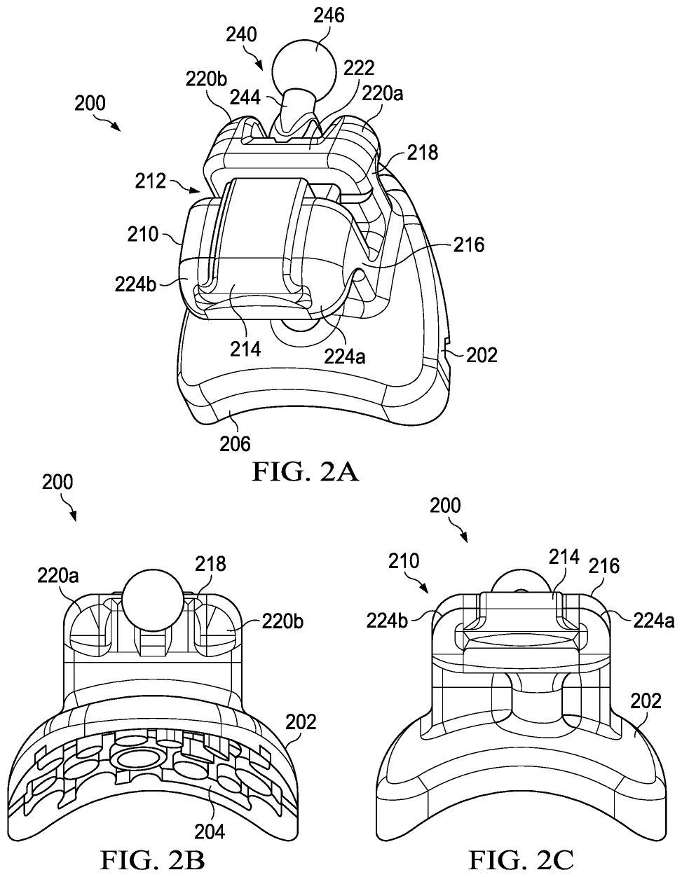

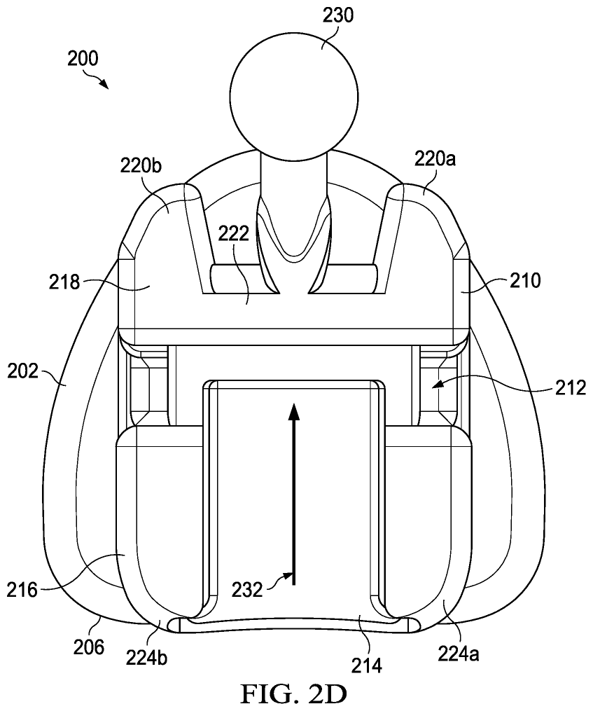

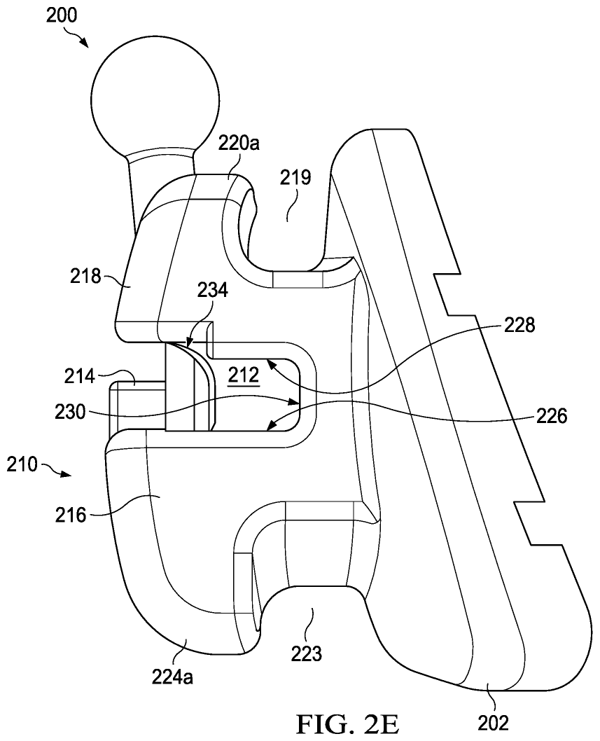

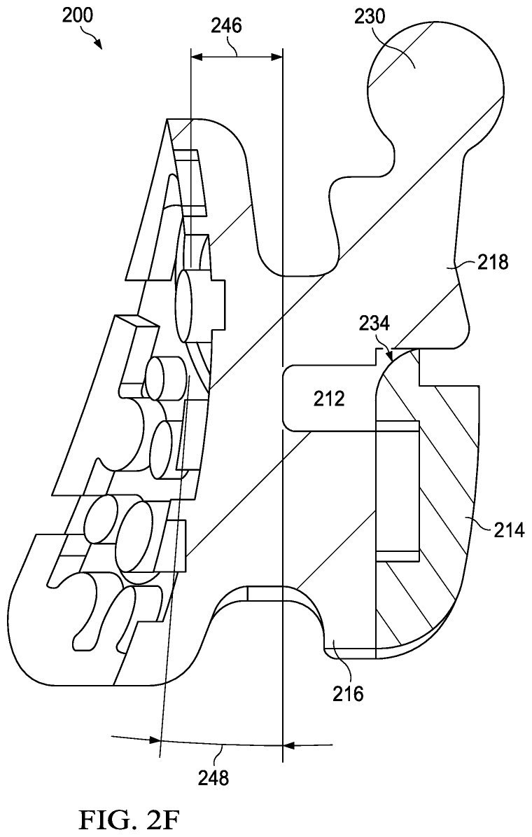

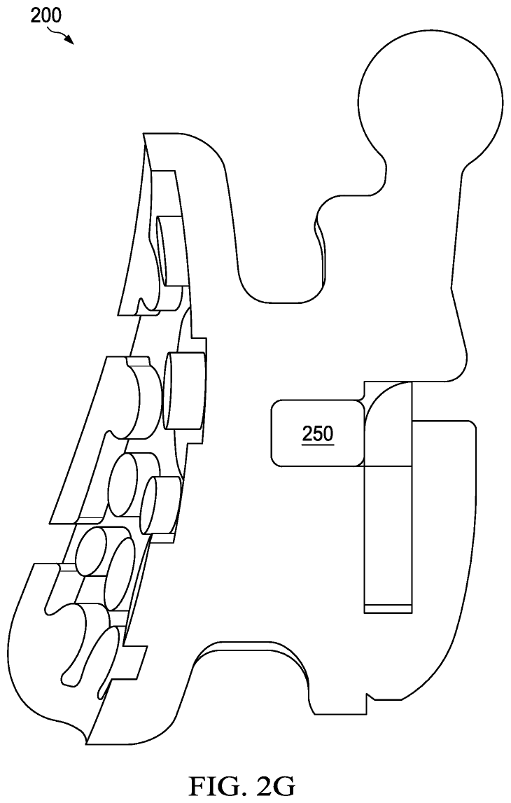

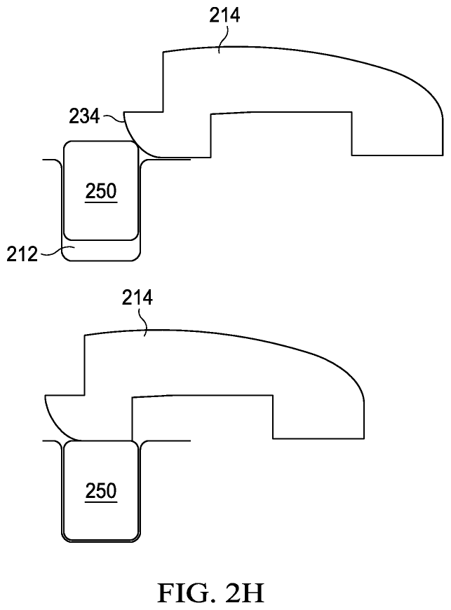

Turning to some example embodiments of brackets, FIG. 2A is a perspective view of a self-ligating premolar bracket 200 according to one embodiment; FIG. 2B is a gingival view of premolar bracket 200 according to one embodiment; FIG. 2C is an occlusal view of premolar bracket 200 according to one embodiment; FIG. 2D is a front view of premolar bracket 200 according to one embodiment; FIG. 2E is a side view of premolar bracket 200 according to one embodiment; FIG. 2F is a cross-sectional view of premolar bracket 200 according to one embodiment; and FIG. 2G is a cross-sectional view of premolar bracket 200 and an archwire 250 according to one embodiment. In addition, FIG. 2H illustrates one embodiment of closing ligating slide 214 to help seat archwire 250.

Premolar bracket 200 includes a base 202 for attachment to the tooth surface, a bracket body 210 defining an archwire slot 212 and a ligating slide 214 to trap the archwire in archwire slot 212. Archwire slot 212 is sized to receive an orthodontic archwire 250 (FIG. 2G) and may include a bevel at the edges of archwire slot 212. According to one embodiment, bracket base 202 includes a tooth attachment surface 204 with a concave contour. Surface 204 may be provided with grooves, particles, recesses, undercuts, a chemical bond enhancement material or any other material or structure or any combination of the foregoing that facilitates bonding premolar bracket 200 directly to the tooth surface. In some embodiments, base 202 has a straight occlusal edge 206 when viewed from the front or from the rear.

A body 210 extends outwardly from base 202 in a generally buccolabial direction and includes an occlusal extension 216 and a gingival extension 218 with archwire slot 212 running between them in a generally mesial-distal direction. These extensions provide tie wings. For example, gingival extension 218 includes gingival tie wings 220a and 220b projecting at the mesial and distal ends of the gingival extension 218 to form tie wing undercut 219. A bridge or wall 222 extends between tie wing 220a to tie wing 220b. Occlusal extension 216 includes a portion that extends out in an occlusal direction to form a tie wing undercut 223 and thus effectively form an occlusal tie wings 224a, 224b. Tie wing undercuts 219, 223 may be relatively deep to easily accept ligatures and power chains. Tie wings 220a, 224a may act as mesial tie wings and tie wings 220b, 224b may act as distal wings or vice versa depending on which side of the oral cavity premolar bracket 200 is installed.

As illustrated in FIG. 2E, occlusal extension 216 forms an occlusal wall 226 of archwire slot 212 and gingival extension 218 forms a gingival wall 228 of archwire slot 212. Accordingly, archwire slot 212 is partially surrounded by occlusal wall 226, a gingival wall 228 and an archwire slot base 230. A fourth wall is provided by ligating slide 214. Archwire slot 212 is constructed to accommodate an archwire 250 (illustrated in FIG. 2F). In the illustrated embodiment, archwire slot is constructed to accommodate a rectangular archwire of a defined shape and size, and more particularly, a rectangular archwire with rounded corners. In some embodiments, the slot height can 0.001 inch greater than the archwire height and the slot depth can be 0.001 inch greater than the archwire depth. According to one embodiment, the slot has a slot height of 0.020 inch and a slot depth of 0.026 inch to accommodate a 0.019″×0.025″ archwire. That is, in FIG. 2E, the distance from occlusal wall 226 to gingival wall 228 is 0.020 inch and the distance from slot base 230 to ligating slide 214 is 0.026 inch. In some embodiments, the orthodontic bracket can have a torsional play value or range, or total play value or range, that produces mechanical properties suited to finishing treatment and additionally exhibiting torsion control.

A gingival hook 240 for attaching elastics between the jaws extends out from wall 222 between tie wing 220a and tie wing 220b. In this embodiment, hook 240 is located at the middle of premolar bracket 200 (the middle moving from the mesial to distal side of premolar bracket 200) and comprises a shaft 242 extending in a gingival direction from wall 222 and a ball 244 to prevent elastics from slipping off of the hook. In some embodiments, hook 240 is positioned so that the long axis of hook 240 aligns with the centerline of premolar bracket 200 or is equidistant to tie wing 220a and tie wing 220b. Gingival hook can be considered a universal hook 240 as premolar bracket 200 can be used on either the left or right side on the same row of teeth. While gingival 240 is illustrated as a straight ball hook, gingival hook 240 may have an L configuration, an inverted L configuration or other configuration in other embodiments.

Ligating slide 214 slides from an open position in which the buccolabial side of archwire slot 212 is open to allow archwire 250 to be inserted in archwire slot 212 to a closed position to trap archwire 250 in archwire slot 212. A scribe line 232 may be marked (e.g. temporarily) along ligating slide 214 as a center line to assist the orthodontist during the bracket bonding procedure to align the bracket with the axial inclination of a clinical crown tooth—that is to align the bracket with the long axis of the tooth. Body 210 and litigating slide 214 may include various features, such as guide paths and rails to guide ligating slide 214 in the correct direction. For example, the face of occlusal extension 216 facing ligating slide may include a guide path in which a projection from ligating slide is disposed to guide ligating slide 214. Ligating slide and body 210 may also include features to provide haptic or an audible “click” feedback when ligating slide 214 reaches a fully closed position or when ligating slide 214 is opened. For example, premolar bracket 200 may include a ligating slide mechanism with an audible click on open and close.

According to one embodiment, ligating slide 214 has a rounded leading edge 234 that is curved for at least a portion of the leading edge from a rear side of ligating slide 214 (the side facing archwire slot 212) to a front side of ligating slide 214. Rounded leading edge 234 of ligating slide 214 can aid in seating full-sized wires. With reference to FIG. 2H, rounded leading edge 234 can contact the (rounded) corner of wire 250 as ligating slide 214 closes helping force wire 250 into archwire slot 212. Thus, the curved portion of rounded leading edge 234 can serve as a wire pushing portion to aid in seating archwire 250.

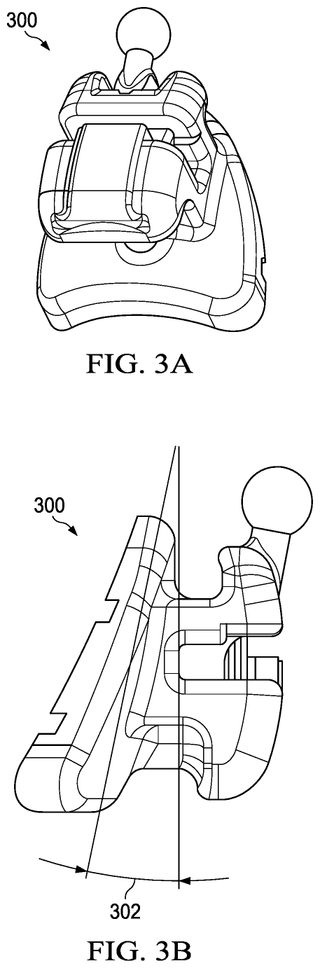

As discussed above, a bracket prescription may be defined by tip, torque, and rotation and an in/out. As will be appreciated, the in/out, tip, torque, and rotation of premolar bracket 200 can be selected to achieve a desired prescription. The in/out is illustrated as distance 246 from the slot base 230 to the tooth attachment surface 204 and the torque is represented by angle (FIG. 2F). The torque is illustrated as torque angle 248 of FIG. 2F. In the illustrated embodiment, bracket 200 has a tip and rotation of 0 and a torque of −5 degrees. FIG. 3A and FIG. 3B, for example, illustrates an example of a similar premolar bracket 300, but with a torque 302 of −12 degrees.

In many prescriptions, the bracket used on a premolar includes a gingival hook, tip, or rotation that prevents identical brackets from being used for a left premolar as the right premolar. For example, a premolar bracket design for an upper right premolar that has a gingival hook located on the distal gingival tie wing cannot be used on the upper left because the gingival hook would then be on the mesial side rather than the distal side, making the appliance asymmetrical. Thus, the bracket used on upper left side tooth would not be identical to the one used on the upper right side but would a version suitable for installation on the left.

According to some embodiments of the present disclosure, an orthodontic appliance may use brackets of the same prescription for multiple premolars. For example, according to one embodiment, all the maxillary premolars have the same prescription. Because of the central location of gingival hook 240, a universal maximal premolar design can be used. With reference to FIG. 1C, for example, first premolar brackets 110, 130 and second premolar brackets 112, 132 may be substantially identical. Similarly, all of the mandibular premolars may all use the same prescription. As such a universal mandibular premolar bracket can be provided that can be used on any of the mandibular premolars. Thus, in some embodiments, first premolar brackets 160, 180 and second premolar brackets 162, 182 may all be substantially identical brackets.

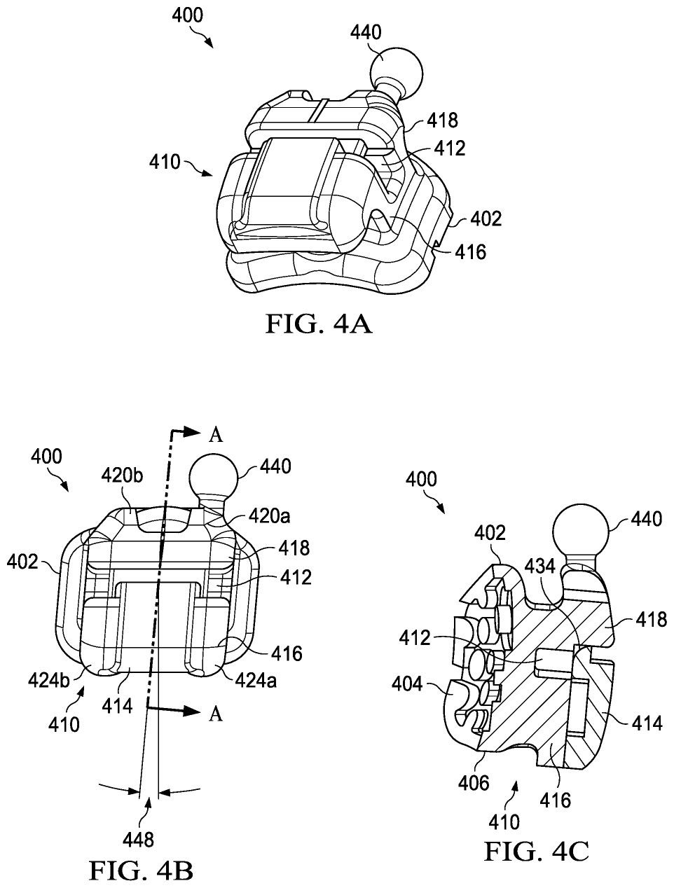

FIG. 4A is a perspective view of a cuspid bracket 400 according to one embodiment. FIG. 4B is a front view of cuspid bracket 400 according to one embodiment. FIG. 4C is a cross-sectional view of cuspid bracket 400 according to one embodiment. As will be appreciated, the in/out, tip (indicated as tip angle 448), torque, rotation, location of elastics hook 440 or other aspects of cuspid bracket 400 can be selected to achieve a desired prescription for a tooth. In the illustrated embodiment, cuspid bracket 400 is suitable for an upper left cuspid (e.g., bracket 400 may be used as cuspid bracket 108). Cuspid brackets for the other cuspids (e.g., cuspid bracket 128, cuspid bracket 158, cuspid bracket 178) may include similar features as cuspid bracket 400, configured for the specific tooth.

Cuspid bracket 400 includes a base 402 for attachment to the tooth surface, a bracket body 410 defining an archwire slot 412 and a ligating slide 414 to trap the archwire in slot 412. Archwire slot 412 is sized to receive an orthodontic archwire and may include a bevel at the edges of archwire slot 412. According to one embodiment, bracket base 402 includes a tooth attachment surface 404 with a concave contour. Surface 404 may be provided with grooves, particles, recesses, undercuts, a chemical bond enhancement material or any other material or structure or any combination of the foregoing that facilitates bonding cuspid bracket 400 directly to the tooth surface. In some embodiments, base 402 has a straight occlusal edge 406 when viewed from the front or from the rear.

A body 410 extends outwardly from base 402 in a generally buccolabial direction and includes an occlusal extension 416 and a gingival extension 418, with archwire slot 412 running between them in a generally mesial-distal direction. These extensions provide tie wings. For example, gingival extension 418 includes gingival tie wings 420a and 420b projecting at the distal and mesial ends of the gingival extension 418. Occlusal extension 416 includes a portion that extends out in an occlusal direction to form a tie wing undercut and thus effectively form an occlusal tie wings 424a, 424b. The tie wing undercuts may be relatively deep to easily accept ligatures and power chains.

Occlusal extension 416 forms an occlusal wall of archwire slot 412 and gingival extension 418 forms a gingival wall of archwire slot 412. Accordingly, archwire slot 412 is partially surrounded by the occlusal wall, the gingival wall and an archwire slot base. A fourth wall is provided by ligating slide 414. Archwire slot 412 is constructed to accommodate an archwire. In the illustrated embodiment, archwire slot is constructed to accommodate a rectangular archwire of a defined shape and size, and more particularly, a rectangular archwire with rounded corners. In some embodiments, the slot height can 0.001 inch greater than the archwire height and the slot depth can be 0.001 inch greater than the archwire depth. According to one embodiment, the slot has a slot height of 0.020 inch and a slot depth of 0.026 inch to accommodate a 0.019″×0.025″ archwire. In some embodiments, cuspid bracket 400 can have a torsional play value or range, or total play value or range, that produces mechanical properties suited to finishing treatment and additionally exhibiting torsion control. A gingival hook 440 for attaching elastics between the jaws extends out from the distal portion of gingival extension 416 and more particularly from tie wing 420a. Gingival hook comprises a shaft extending in a generally gingival direction from gingival extension 418 and a ball to prevent elastics from slipping off of the hook. While hook 440 is illustrated as extending from the distal tie wing, in other embodiments, hook 440 may extend from between the tie wings or from the mesial tie wing. Further, while hook 440 is illustrated as a straight ball hook, hook 440 may have an L configuration, and inverted L configuration or other configuration in other embodiments.

Ligating slide 414 slides from an open position in which the buccolabial side of archwire slot 412 is open to allow the archwire to be inserted in archwire slot 412 to a closed position to trap the archwire in archwire slot 412. A scribe line (not shown) may be marked (e.g. temporarily) along ligating slide 414 as a center line to assist the orthodontist during bracket bonding procedure to align the bracket with the axial inclination of a clinical crown tooth. According to one embodiment, ligating slide 414 has a rounded leading edge 434 that is curved for at least a portion of the leading edge from a rear side of ligating slide 414 (the side facing archwire slot 412) to a front side of ligating slide 414. The curved portion of rounded leading edge 434 can serve as a wire pushing portion to push the archwire into archwire slot 412. Thus, rounded leading edge 434 of ligating slide 414 can aid in seating full-sized wires.

Body 410 and litigating slide 414 may include various features, such as guide paths and rails to guide ligating slide 414 in the correct direction. For example, the face of occlusal extension 418 facing ligating slide may include a guide path in which a projection from ligating slide is disposed to guide ligating slide 414. Ligating slide and body 410 may also include features to provide haptic or an audible “click” feedback when ligating slide 414 reaches a fully closed position or when ligating slide 414 is opened. For example, bracket 400 may include a ligating slide mechanism with an audible click on open and close.

As will be appreciated, the in/out, tip, torque, and rotation of cuspid bracket 400 can be selected to achieve a desired prescription. According to some embodiments of the present disclosure, an orthodontic appliance may use brackets of the same prescription for multiple cuspids. For example, all the cuspids may use the same prescription. If the lower right cuspid has the same prescription as the upper left cuspid, brackets 400 having the same design can be used on the upper left cuspid and lower right cuspid (e.g., cuspid brackets 108, 178 can be substantially identical). However, bracket 400 has gingival hook 440 located on the distal gingival tie wing 420a. If such a bracket 400 is used on the upper right cuspid (e.g., as cuspid bracket 128), gingival hook 440 would be on the mesial side rather than the distal side, making the appliance asymmetrical. Thus, one of ordinary skill in the art would understand that a bracket identical to the one used on the upper left side (e.g., as cuspid bracket 108) would not be used on the upper right side, but instead a version suitable for installation on the right would be used. For example, if the upper right cuspid and lower left cuspid have the same prescription as the upper left cuspid, a mirror image of cuspid bracket 400 could be used for cuspid bracket 128 and cuspid bracket 158 in some embodiments.

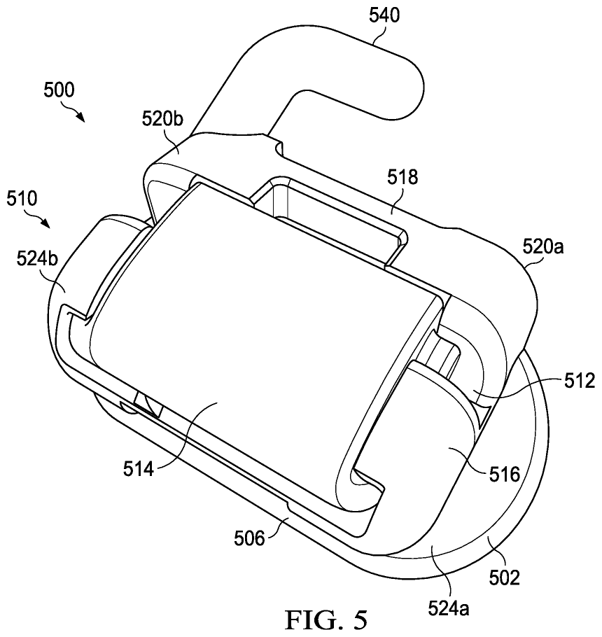

FIG. 5 is a perspective view of a first molar bracket 500 according to one embodiment. As will be appreciated, the in/out, tip, torque, rotation, location of gingival hook 540 or other aspects of first molar bracket 500 can be selected to achieve a desired prescription for a tooth. In the illustrated embodiment, first molar bracket 500 is configured for an upper left tooth (e.g., first molar bracket 500 may be used as first molar bracket 114). First molar brackets for the other first molars (e.g., first molar brackets 134, first molar bracket 164, first molar bracket 184) may include similar features as first molar bracket 500, configured for the specific tooth.

Molar bracket 500 includes a base 502 for attachment to the tooth surface, a bracket body 510 defining an archwire slot 512 and a ligating slide 514 to trap the archwire in slot 512. Archwire slot 512 is sized to receive an orthodontic archwire and may include a bevel at the edges of archwire slot 512. According to one embodiment, bracket base 502 includes a tooth attachment surface with a concave contour. The tooth attachment surface may be provided with grooves, particles, recesses, undercuts, a chemical bond enhancement material or any other material or structure or any combination of the foregoing that facilitates bonding molar bracket 500 directly to the tooth surface. In some embodiments, base 502 has a straight occlusal edge 506 when viewed from the front or from the rear.

A body 510 extends outwardly from base 502 in a generally buccolabial direction and includes an occlusal extension 516 and a gingival extension 518, with archwire slot 512 running between them in a generally mesial-distal direction. These extensions may provide tie wings. For example, gingival extension 518 includes a portion that extends out in gingival direction to form a tie wing undercut and tie wings 520a and 520b at the distal and mesial ends of the gingival extension 518. Occlusal extension 516 includes a portion that extends out in an occlusal direction to form a tie wing undercut and thus effectively form an occlusal tie wings 524a, 524b. The tie wing undercuts may be relatively deep to easily accept ligatures and power chains.

Occlusal extension 516 forms an occlusal wall of archwire slot 512 and gingival extension 518 forms a gingival wall of archwire slot 512. Accordingly, archwire slot 512 is partially surrounded by the occlusal wall, the gingival wall and an archwire slot base. A fourth wall is provided by ligating slide 514. Archwire slot 512 is constructed to accommodate an archwire. In the illustrated embodiment, archwire slot is constructed to accommodate a rectangular archwire of a defined shape and size, and more particularly, a rectangular archwire with rounded corners. In some embodiments, the slot height can 0.001 inch greater than the archwire height and the slot depth can be 0.001 inch greater than the archwire depth. According to one embodiment, the slot has a slot height of 0.020 inch and a slot depth of 0.026 inch to accommodate a 0.019″×0.025″ archwire. In some embodiments, orthodontic cuspid bracket 500 can have a torsional play value or range, or total play value or range, that produces mechanical properties suited to finishing treatment and additionally exhibiting torsion control. A gingival hook 540 for attaching elastics between the jaws extends out from the mesial portion of gingival extension 518. Gingival hook comprises a mesial “L” shaped hook pointing in the distal direction. In another embodiment, gingival hook comprises a distal inverted “L” shaped hook pointing in the mesial direction.

Ligating slide 514 slides from an open position in which the buccolabial side of archwire slot 512 is open to allow the archwire to be inserted in archwire slot 512 to a closed position to trap the archwire in archwire slot 512. A scribe line (not shown) may be marked (e.g. temporarily) along ligating slide 514 as a center line to assist the orthodontist during bracket bonding procedure to align the bracket with the axial inclination of a clinical crown tooth. According to one embodiment, ligating slide 514 has a rounded leading edge that is curved for at least a portion of the leading edge from a rear side of ligating slide 514 (side facing archwire slot 512) to a front side of ligating slide 514. The curved portion of the rounded leading edge can serve as a wire pushing portion to push the archwire into archwire slot 512 as ligating slide 514 closes. Thus, the rounded leading edge of ligating slide 514 can aid in seating full-sized wires.

Body 510 and litigating slide 514 may include various features, such as guide paths and rails to guide ligating slide 514 in the correct direction. For example, the face of occlusal extension 516 facing ligating slide may include a guide path in which a projection from ligating slide is disposed to guide ligating slide 514. Ligating slide and body 510 may also include features to provide haptic or an audible “click” feedback when ligating slide 514 reaches a fully closed position or when ligating slide 514 is opened. For example, bracket 500 may include a ligating slide mechanism with an audible click on open and close.

As will be appreciated, the in/out, tip, torque, and rotation of cuspid bracket 500 can be selected to achieve a desired prescription. According to some embodiments of the present disclosure, an orthodontic appliance may use brackets of the same prescription for multiple molars. If the lower right first molar has the same prescription as the upper left first molar, a bracket 500 having the same design can be used on the upper left first molar and lower right first molar (e.g., premolar brackets 114 and 184 can be substantially identical according to one embodiment). However, bracket 500 has a mesial gingival hook 540. If such a bracket 500 is used on the upper right first molar (e.g., as first molar bracket 134), gingival hook 540 would be on the distal side rather than the distal side, making the appliance asymmetrical. Thus, one of ordinary skill in the art would understand that a bracket identical to the one used on the upper left side (e.g., as first molar bracket 114) would not be used on the upper right side, but instead a version suitable for installation on the right would be used. For example, if the upper right first molar has the same prescription as the upper left first molar, a mirror image of first molar bracket 500 could be used for first molar bracket 134. Similarly, first molar brackets 184, 164 may be mirror images of each other.

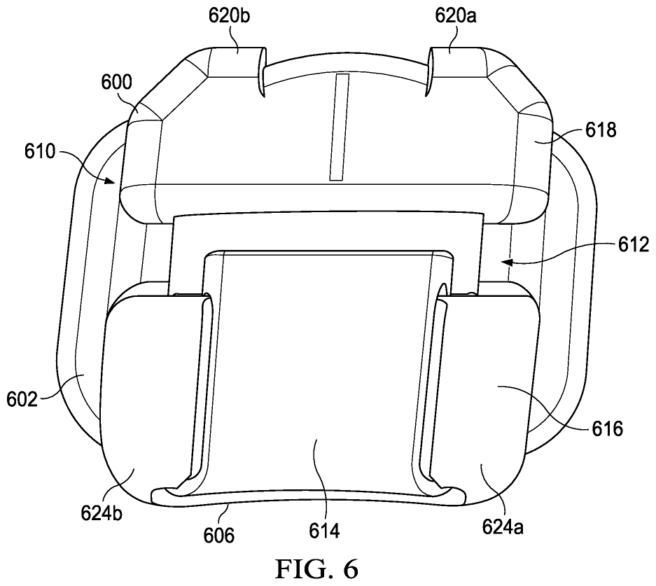

FIG. 6 is a perspective view of an incisor bracket according to one embodiment. As will be appreciated, the in/out, tip, torque, rotation, or other aspects of incisor bracket 600 can be selected to achieve a desired prescription for a tooth. In the illustrated embodiment, incisor bracket 600 is configured for an upper left tooth (e.g., incisor bracket 600 may be used as central incisor bracket 104). Incisor brackets for the other first molars (e.g., central incisor bracket 124, lateral incisor bracket 106, central incisor bracket 154, lateral incisor bracket 156, central incisor bracket 174, lateral incisor bracket 176) may include similar features as incisor bracket 600, configured for the specific tooth.

Incisor bracket 600 includes a base 602 for attachment to the tooth surface, a bracket body 610 defining an archwire slot 612 and a ligating slide 614 to trap the archwire in slot 512. Archwire slot 612 is sized to receive an orthodontic archwire and may include a bevel at the edges of archwire slot 612. According to one embodiment, bracket base 602 includes a tooth attachment surface with a concave contour. The tooth attachment surface may be provided with grooves, particles, recesses, undercuts, a chemical bond enhancement material or any other material or structure or any combination of the foregoing that facilitates bonding molar bracket 500 directly to the tooth surface. In some embodiments, base 602 has a straight occlusal edge 606 when viewed from the front or from the rear.

A body 610 extends outwardly from base 602 in a generally buccolabial direction and includes an occlusal extension 616 and a gingival extension 618, with archwire slot 612 running between them in a generally mesial-distal direction. These extensions may provide tie wings. For example, gingival extension 618 includes a portion that extends out in gingival direction to form a tie wing undercut and tie wings 620a and 620b at the distal and mesial ends of the gingival extension 618. Occlusal extension 616 includes a portion that extends out in an occlusal direction to form a tie wing undercut and thus effectively form an occlusal tie wings 624a, 624b. The tie wing undercuts may be relatively deep to easily accept ligatures and power chains.

Occlusal extension 616 forms an occlusal wall of archwire slot 612 and gingival extension 618 forms a gingival wall of archwire slot 612. Accordingly, archwire slot 612 is partially surrounded by the occlusal wall, the gingival wall and an archwire slot base. A fourth wall is provided by ligating slide 614. Archwire slot 612 is constructed to accommodate an archwire. In the illustrated embodiment, archwire slot is constructed to accommodate a rectangular archwire of a defined shape and size, and more particularly, a rectangular archwire with rounded corners. In some embodiments, the slot height can 0.001 inch greater than the archwire height and the slot depth can be 0.001 inch greater than the archwire depth. According to one embodiment, the slot has a slot height of 0.020 inch and a slot depth of 0.026 inch to accommodate a 0.019″×0.025″ archwire. In some embodiments, incisor bracket 600 can have a torsional play value or range, or total play value or range, that produces mechanical properties suited to finishing treatment and additionally exhibiting torsion control.

Ligating slide 614 slides from an open position in which the buccolabial side of archwire slot 612 is open to allow the archwire to be inserted in archwire slot 612 to a closed position to trap the archwire in archwire slot 612. A scribe line (not shown) may be marked (e.g. temporarily) along ligating slide 614 as a center line to assist the orthodontist during bracket bonding procedure to align the bracket with the axial inclination of a clinical crown tooth. According to one embodiment, ligating slide 614 has a rounded leading edge that is curved for at least a portion of the leading edge from a rear side of ligating slide 614 (side facing archwire slot 612) to a front side of ligating slide 614. The curved portion of the rounded leading edge can serve as a wire pushing portion to push the archwire into archwire slot 612 as ligating slide 614 closes. Thus, the rounded leading edge of ligating slide 614 can aid in seating full-sized wires.

Body 610 and litigating slide 614 may include various features, such as guide paths and rails to guide ligating slide 614 in the correct direction. For example, the face of occlusal extension 616 facing ligating slide may include a guide path in which a projection from ligating slide is disposed to guide ligating slide 614. Ligating slide and body 610 may also include features to provide haptic or an audible “click” feedback when ligating slide 614 reaches a fully closed position or when ligating slide 614 is opened. For example, bracket 600 may include a ligating slide mechanism with an audible click on open and close.

According to some embodiments of the present disclosure, certain incisors may have the same prescription. However, bracket 600 may have a tip such that if bracket 600 was used on the upper right central incisor (e.g., as central incisor bracket 124), the bracket would be tipped in the wrong direction. One of ordinary skill in the art would understand that the bracket used on upper right central incisor can be the mirror image of the one used on the upper left central incisor. Similarly, the bracket used on the upper lateral incisors can be mirror images of each other. In some embodiments all the lower incisors have the same prescription and, thus, substantially identical brackets can be used for central incisor brackets 154, 174 and lateral incisor brackets 156, 176.

The brackets of FIGS. 1A-1C and brackets 200, 300, 400, 500 and 600 are merely non-limiting examples of different types of brackets that can incorporate a 0.020″×0.026″ slot and various other bracket designs can be adapted for a 0.020″×0.026″ slot. One of skill in the art will appreciate that various types of brackets can be manufactured to achieve desired tips, torques, rotations, in/out.

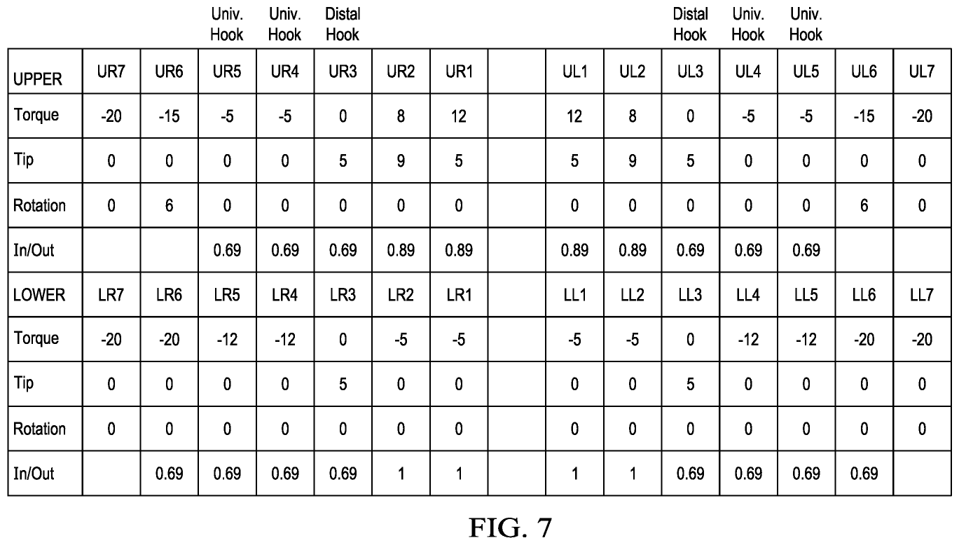

Thus, an orthodontic appliance can be formed using brackets having 0.020″×0.026 slot size, such as the brackets discussed above or other brackets. FIG. 7 illustrates one embodiment of 20/26 prescription (torque, tip and rotation are given in degrees and in/out in inches) for an appliance using a 0.020″×0.026″ slot size. As will be appreciated, different types of brackets may be used on different teeth, with the bracket for each tooth manufactured to achieve the desired prescription for that tooth.

An orthodontic appliance according to the 20/26 Prescription of FIG. 7 may use substantially identical brackets on multiple teach. Thus, in addition to the advantages provided by using the 0.020″×0.026″ slot size, the example 20/26 Prescription can reduce the number of different bracket designs required for the orthodontic appliance, thereby reducing manufacturing complexity and cost.

For example, it can be noted that the upper right first premolar (UR4) and upper right second premolar (UR5) have the same prescription. Consequently, identical brackets can be used for UR4 and UR5. Similarly, upper left first premolar (UL4) and upper left second premolar (UL5) have the same prescription and can therefore use identical brackets. Moreover, UL4 and UL5 have the same prescription as UR4 and UR5. In many prescriptions, the bracket used on a premolar includes a gingival hook, tip, or rotation that prevents identical brackets from being used for a left premolar as the right premolar. However, embodiments described herein may have a tip and rotation and use a universal premolar hook as described in conjunction with bracket 200 such that identical brackets can be used on the left and right side. Using the example of FIG. 1C, the same bracket design (e.g., premolar bracket 200) may be used for premolar brackets 110, 112, 130, 132 and the same bracket design (e.g., premolar bracket 300) may be used for premolar brackets 160, 162, 180, 182. As will be appreciated then, an orthodontic appliance can use the same bracket for the upper first premolar and the upper second premolar and further, the same bracket for the right premolars and the left premolars. In other words, a universal maxillary bracket can be provided which will fit all mandibular premolars and multiple such universal premolar brackets may be used in an orthodontic appliance.

Returning to FIG. 7 and the example 20/26 Prescription, lower right first premolar (LR4) and lower right second premolar (LR5) have the same prescription. Consequently, the same bracket design can be used for LR4 and LR5. Similarly, lower left first premolar (LL4) and lower left second premolar (LL5) have the same prescription and can therefore use the same bracket design. Moreover, LR4, LR5, LL4 and LL5 all have the same prescription without tip or rotation. Thus, the same bracket design using a universal premolar hook can be used for LR4, LR5, LL4, LL5. For example, the same bracket design (e.g., premolar bracket 300) may be used for premolar brackets 160, 162, 180, 182. As will be appreciated then, an orthodontic appliance can use substantially identical brackets for the lower first premolar and the lower second premolar and further, the substantially identical brackets for the right premolars and the left premolars. In other words, a universal premolar bracket can be provided which will fit all mandibular premolars and multiple such universal premolar brackets may be used in an orthodontic appliance.

It can also be noted that upper right cuspid (UL3) and lower left cuspid (LR3) have the same prescription. It will be appreciated that a bracket manufactured to have torque: 0, tip: 5, rotation: 0, in/out: 0.69, for UL3 may have torque: 0, tip: 5, rotation: 0, in/out: 0.69 for LR3 when the bracket is reoriented and repositioned for use on LR3. Thus, the same bracket design (e.g., bracket 400) can be used for UL3 and LR3. Similarly, the upper right cuspid (UR3) and lower left cuspid (LL3) have the same prescription and can use substantially identical brackets. In some embodiments, for example, cuspid bracket 128 and cuspid bracket 178 may be substantially identical, having the same structural design, but have differences in surface ornamentation, such as markings or colored dots, to indicate which bracket should be attached to UL3 and which bracket should be attached to LR3. Similarly, cuspid bracket 128 and cuspid bracket 158 may be substantially identical, having the same structural design, but with differences in surface ornamentation, such as markings or colored dots to indicate which bracket should be attached to UR3 and which bracket should be attached to LL3.

As will be appreciated then, an appliance prescription that uses the same prescription for multiple teeth and the use of a bracket that can meet the prescription requirements for multiple teeth reduces manufacturing complexity, time and cost as fewer different designs have to be manufactured. The prescription of FIG. 7 is provided by way of example and not limitation and embodiments of brackets can adhere to other prescriptions.

While embodiments herein have been described primarily in terms of a 0.020″×0.026″ slot size, it will be appreciated that various embodiments may use other slot sizes. For example, embodiments may include prescriptions for other slot sizes, where the prescription allows the use of universal premolar bracket that will fit all maxillary premolars, a universal premolar bracket that will fit all mandibular premolars, and or a bracket that will multiple other teeth.

According to one embodiment, a bracket can include, for example, a mesial occlusal tie wing, a distal occlusal tie wing, mesial gingival tie wing, and a distal gingival tie wing. A mesial to distal extending archwire slot (e.g., slot 212, 412, 512, 612), can be located between the gingival tie wings and the occlusal tie wings.

A bracket can have a slot size that is variable in both the occlusal gingival and facial lingual dimension. An aspect in reducing friction and binding forces is the contact of the wire with the archwire slot floor, or lingual surface of the bracket slot. There are a variety of available designs that are used for the lingual surface or the bracket slot floor. Some designs are continuous from mesial to distal and some are split in the middle between the tie wings.

According to one aspect of the present disclosure, a bracket (e.g., such as the brackets illustrated in FIG. 1A-1C, bracket 200, bracket 300, bracket 400, bracket 500, bracket 600) has a torsional play value in the clockwise direction or the counter clockwise direction when used with a 0.019″×0.025″ wire. The torsional play value can be any value producing mechanical properties suited to finishing treatment and additionally exhibiting torsion control. Examples of torsional control values that are contemplated herein include, but are not limited to, values less than 13 degrees in both the clockwise and counterclockwise direction, less than 12 degrees in both the clockwise and counterclockwise direction, less than 11 degrees in both the clockwise and counterclockwise direction, less than 10 degrees in both the clockwise and counterclockwise direction, less than 9 degrees in both the clockwise and counterclockwise direction, less than 8 degrees in both the clockwise and counterclockwise direction, less than 7 degrees in both the clockwise and counterclockwise direction, less than 6 degrees in both the clockwise and counterclockwise direction, less than 5 degrees in both the clockwise and counterclockwise direction, less than 4 degrees in both the clockwise and counterclockwise direction, less than 3 degrees in both the clockwise and counterclockwise direction, less than 2 degrees in both the clockwise and counterclockwise direction, less than 1 degrees in both the clockwise and counterclockwise direction. Further examples include torsional control values from 1 to 13 degrees in both the clockwise and counterclockwise direction, as well as but not limited to the ranges of 1 to 12, 1 to 11, 1 to 10, 1 to 9, 1 to 8, 1 to 7, 1 to 6, 1 to 5, 1 to 4, 1 to 3, 1 to 2, 2 to 13, 3 to 13, 4 to 13, 5 to 13, 6 to 13, 7 to 13, 8 to 13, 9 to 13, 10 to 13, 11 to 13, 12 to 13, 12 to less than 13, 11 to less than 13, 10 to less than 13, 9 to less than 13, 8 to less than 13, 7 to less than 13, 6 to less than 13, 5 to less than 13, 4 to less than 13, 3 to less than 13, 2 to less than 13, 1 to less than 13, 6 to 7, 5 to 8, 4 to 9, 3 to 10, and 2 to 11; all in both the clockwise and counterclockwise direction.

In still another embodiment an orthodontic bracket (e.g., such as the brackets illustrated in FIG. 1A-1C, bracket 200, bracket 300, bracket 400, bracket 500, bracket 600) has a total play value has a torsional play value in the clockwise direction or the counter clockwise direction when used with a 0.019″×0.025″ wire. The total play value can be any value producing mechanical properties suited to finishing treatment and additionally exhibiting torsion control. Examples of total control values that are contemplated herein include, but are not limited to, values of total play less than 26, 25, 24, 23, 22, 21 20, 19, 18, 17, 16, 15, 14, 13, 12, 11, 10, 9, 8, 7, 6, 5, 4, 3, 2, and 1 degrees. Further examples include, but are not limited to, total control values from 1 to 26 degrees, as well as the ranges of 1 to 25, 1 to 24, 1 to 23, 1 to 22, 1 to 21, 1 to 20, 1 to 19, 1 to 18, 1 to 17, 1 to 16, 1 to 15, 1 to 14, 1 to 13, 1 to 12, 1 to 11, 1 to 10, 1 to 9, 1 to 8, 1 to 7, 1 to 6, 1 to 5, 1 to 4, 1 to 3, 1 to 2, 2 to 26, 3 to 26, 4 to 26, 5 to 26, 6 to 26, 7 to 26, 8 to 26, 9 to 26, 10 to 26, 11 to 26, 12 to 26, 13 to 26, 14 to 26, 15 to 26, 16 to 26, 17 to 26, 18 to 26, 19 to 26, 20 to 26, 21 to 26, 22 to 26, 23 to 26, 24 to 26, 25 to 26, 25 to less than 26, 24 to less than 26, 23 to less than 26, 22 to less than 26, 21 to less than 26, 20 to less than 26, 19 to less than 26, 18 to less than 26, 17 to less than 26, 16 to less than 26, 15 to less than 26, 14 to less than 26, 13 to less than 26, 12 to less than 26, 11 to less than 26, 10 to less than 26, 9 to less than 26, 8 to less than 26, 7 to less than 26, 6 to less than 26, 5 to less than 26, 4 to less than 26, 3 to less than 26, 2 to less than 26, 1 to less than 26, 13 to 14, 12 to 15, 11 to 16, 10 to 17, 9 to 18, 8 to 19, 7 to 20, 6 to 21, 5 to 22, 4 to 23, 3 to 24, 2 to 25.

The person of skill in the art will understand that the present disclosure is capable of being used with many different types of orthodontic braces, brackets, and other structures. While various brackets illustrated in FIG. 1A through FIG. 6 are illustrated as self-ligating brackets, other embodiments may include one or more central incisor brackets, lateral incisor brackets, cuspid brackets, premolar brackets or molar brackets that permit the engagement of an archwire into an archwire slot by ligation using elastomeric or wire ligatures wrapped around the tie wings of the bracket. For a self-ligating bracket, the ligating slide is displaced to open or close the archwire slot so as to retreat or retain the archwire, respectively. Meanwhile, the play between the sizes of the bracket slot and the archwire permit the sliding of the tooth along the archwire with less friction and/or resistance. In addition, because the design is without ligature wire, tooth cleansing becomes an easier chore for the patient. A self-ligating bracket may also allow the use of ligatures in some cases.

A self-ligating orthodontic bracket can comprise, for example, a bracket body and a ligating slide. The bracket body may be further described as comprising a mounting base having a concavely contoured surface suitable for attachment to a tooth, a main archwire slot formed upon said base, and sized for receiving an orthodontic archwire, a bracket deck and a resilient retention feature, and a ligating slide overlaying the archwire slot in a closed position. The unique resilient retention feature can be constructed as part of the orthodontic bracket so as to stably and firmly hold the ligating slide in an open position for retrieving the wire, or in a closed position for retaining the archwire, within the archwire slot. The bracket can also be constructed in such a way as to be resistant to slippage off of the bracket body.

According to one embodiment, self-ligating bracket, such as illustrated in FIG. 1 through FIG. 6, may incorporate a resilient retention feature and corresponding features on the ligating slide such as described in U.S. Pat. No. 8,992,21, entitled “Orthodontic Self-Ligating Brackets,” by Wu et al., which is hereby fully incorporated by reference herein for all purposes. In some embodiments, a retention feature of a self-ligating bracket may be described as comprising a modified dumbbell channel that is defined by a narrow shaft and two wider spaced apart concentric circles. One of the circular ends can function as a slide stop circle, and functions to retain the ligating slide in its open position when in operation, as well as to prevent sliding movement that might result in the disengagement of the ligating slide from the bracket. Another circular end which is located adjacent to the archwire slot, can present a truncated cup-like holding circle design, and functions to secure the ligating slide in its closed position, and thereby retain the archwire within the archwire slot of the bracket. The two circular relief areas can be designed to accommodate a gear, which is a cylindrical protrusion in the underside of the ligating slide, to seat in the open and the closed position.

The bracket can further comprise a bracket deck. The bracket deck can be characterized by several relief areas. These relief areas are suitable for the purpose of securing the open and closed position of the ligating slide of the bracket system without slipping off the bracket body. In some embodiments, the resilient retention features reside within the bracket body of the self-ligating bracket. The resilient feature is designed to provide an S shaped resilient retention feature that resides in between the modified dumbbell channel and the lake of the deck. The deck, in more detail, includes three elongated relief areas, namely a modified dumbbell relief area with two spaced-apart concentric circles at both ends and a detent middle portion. The lake resides in the center among the relief areas. A cylindrical post travels in between the two circles, the cylindrical post being built in the underside of the ligating slide. Thus, the concert efforts of the post in the ligating slide and relief area within the bracket body provide a controlling mechanism in the current devise construct.

The front outer surface of the device construct can be smoothly designed and can be constructed so as to avoid the inclusion of unnecessary features. This plain smooth surface provides, among other advantages, the feature of minimizing the trapping any food debris or accumulation of plaque.

The ligation slide may be made of any variety of appropriate materials with strength and structural integrity, including but not limited to stainless steel or zirconia, and may be fabricated to include any variety of colors of the patient's choice, so as to even further enhance patient preference and satisfaction. By way of example, the ligation slide can be made of materials such as cobalt chromium alloys, stainless steel, ceramic, alumina, or zirconia with various colors including white, black, pink, yellow, green, dark blue and others. The color-coded ligating slide, by way of further example, may be fabricated so as to include the color of choice according to the patient's selection.

In some embodiments, the ligation slide may be described as having a relatively thick construction and as having sufficient structural mechanical strength strong enough to resist significant strain and/or distortion, such as that which may be caused by the archwire. The ligation slide thus is constructed so as to be capable of holding a twisted wire in a contortion that maintains a proper torque correction of the crown or root when in place in the oral cavity. In use, the ligation slide may function to relay mechanical force to the tooth during treatment when used in concert with the archwire.

In some embodiments, one or more brackets may further include an auxiliary archwire slot for an additional archwire, this additional archwire being incorporated in the rotational and/or torque control of specific teeth. Self-ligating bracket may include rugged bottom to the bracket base. This feature, among other things, functions to increase surface area for the extra-bonding materials to adhere and to produce a mechanical anchor effect to the teeth, in addition to the inherent chemical binding ability of the bonding materials.

Another aspect of the present disclosure can provide for an improved orthodontic bracket that may be used to provide a treatment objective for the correction of rotated teeth in a patient, in particular rotation of the front teeth. Among the crowded or crooked teeth, the main contributing factor can be defined as the rotation of a tooth or teeth. Thus, a method for the correction of a rotated tooth or teeth with the herein described orthodontic bracket system is provided and is particularly applicable for correction of this orthodontic problem in the front area, correcting for an awkward tooth crowding situation.

Embodiments of brackets described herein can provide for the early correction of rotated teeth with adequate time for the subsequent remodeling of the underlying tissue throughout the treatment. A wider mesial-distal dimension of the bracket width serves the purpose, for example, of rotating a tooth, among other purposes. Accordingly, the bracket widths corresponding to the mesio-distal dimension of the upper or lower teeth would appear wider or narrower within the minimal operative width, respectively. The occluso-gingival vertical heights of the brackets maintain even. In general, and in some embodiments, the front view of a bracket width reflects the width of a tooth.

In some cases, orthodontic straight wire mechanics may demand that the archwire, when engaged in the archwire slot of a bracket, does not require additional bending at certain stage during, along and thereafter treatment. Built-in angulations of the brackets can be used to comply with the variations in the in-and-out offset differences in the occlusal view of the dentition, in the highest contour points of the labial or buccal teeth, and in the occluso-gingival curvatures of the teeth profile relative to the related bone ridge, so called first (in and out), second (tip or tilt), and third order (torque) variations, respectively. Accordingly, the archwire slots can be constructed to adopt these variations so as to engage a plain curved archwire at an early stage of the dental arch leveling. According to one embodiment, the bracket base with its body housing the archwire slot is built with a design of the torque-in-base by a one-piece metal injection mold (MIM). In some embodiments, the device can be formed by other materials and/or through alternative mold process, for example, by a one-piece ceramic-injection mold (CIM).

Some embodiments of a self-ligating bracket also include a hook. The hook can be built and added to the brackets at the distal tie wing or the mesial tie wing of the gingival extension of the bracket to assist in the engagement of the power chain, coil spring or other structure(s) of the dental corrective device. In another embodiment, the hook may be located at the middle of the bracket (e.g., between mesial and distal tie wings). In one embodiment, the hook is a straight hook, such as a straight ball hook. In other embodiments, the self-ligating bracket comprises a hook that has an L configuration, an inverted L configuration or other configuration.

It will be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, product, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the meaning of “in” includes “in” and “on” unless the context clearly dictates otherwise.

Reference throughout this specification to “one embodiment”, “an embodiment”, or “a specific embodiment” or similar terminology means that a particular feature, structure, or characteristic described in connection with the embodiment is included in at least one embodiment and may not necessarily be present in all embodiments. Thus, respective appearances of the phrases “in one embodiment”, “in an embodiment”, or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms. Language designating such nonlimiting examples and illustrations includes, but is not limited to: “for example,” “for instance,” “e.g.,” “in one embodiment.”

Thus, while the invention has been described with respect to specific embodiments thereof, these embodiments are merely illustrative, and not restrictive of the invention. Rather, the description (including the and Summary and Abstract) is intended to describe illustrative embodiments, features and functions in order to provide a person of ordinary skill in the art context to understand the invention without limiting the invention to any particularly described embodiment, feature or function, including any such embodiment feature or function described. While specific embodiments of, and examples for, the invention are described herein for illustrative purposes only, various equivalent modifications are possible within the spirit and scope of the invention, as those skilled in the relevant art will recognize and appreciate.

As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. An orthodontic appliance comprising:
a plurality of orthodontic brackets, each orthodontic bracket of the plurality of orthodontic brackets comprising:
a bracket base for bonding the orthodontic bracket to a respective tooth; and
a bracket body extending from the bracket base, the bracket body defining an archwire slot having 0.020-inch slot height and 0.026-inch slot depth and adapted to retain an archwire having a 0.019-inch wire height and a 0.025-inch wire depth; and
wherein the plurality of orthodontic brackets includes a first orthodontic bracket and second orthodontic bracket, the first orthodontic bracket installable according to a prescription on either a left side of an oral cavity or a right side of the oral cavity on a first row of teeth, the second orthodontic bracket being substantially identical to the first orthodontic bracket.

2. The orthodontic appliance of claim 1, wherein each orthodontic bracket from the plurality of orthodontic brackets has a total torsional play of less than twenty-six degrees.

3. The orthodontic appliance of claim 1, wherein each orthodontic bracket from the plurality of orthodontic brackets comprises a ligating slide, the ligating slide movable from an open position to a closed position to retain the archwire in the archwire slot of the orthodontic bracket.

4. The orthodontic appliance of claim 3, wherein the ligating slide comprises a front surface, a rear surface, and a leading edge having a curved wire pushing portion.

5. The orthodontic appliance of claim 4, wherein the leading edge is curved from the rear surface to the front surface.

6. The orthodontic appliance of claim 1, wherein the first orthodontic bracket and the second orthodontic bracket each comprise a universal gingival hook.

7. The orthodontic appliance of claim 6, wherein the first orthodontic bracket and the second orthodontic bracket are universal maxillary premolar brackets.

8. The orthodontic appliance of claim 6, wherein the first orthodontic bracket and the second orthodontic bracket are universal mandibular premolar brackets.

9. The orthodontic appliance of claim 6, wherein the bracket body of the first orthodontic bracket comprises:
a mesial gingival tie wing;
a distal gingival tie wing; and
a gingival wall extending between the mesial gingival tie wing the distal gingival tie wing, the universal gingival hook extending from the gingival wall between the mesial gingival tie wing and the distal gingival tie wing.

10. The orthodontic appliance of claim 9, wherein the universal gingival hook is a straight ball hook.

11. The orthodontic appliance of claim 1, wherein the plurality of orthodontic brackets includes a third orthodontic bracket for installation on the first row of teeth and a fourth orthodontic bracket for installation on the first row of teeth, the third orthodontic bracket and the fourth orthodontic bracket being substantially identical to the first orthodontic bracket and the second orthodontic bracket.

12. The orthodontic appliance of claim 11, wherein the first orthodontic bracket, the second orthodontic bracket, the third orthodontic bracket and the fourth orthodontic bracket are premolar brackets.

13. The orthodontic appliance of claim 1, wherein the plurality of orthodontic brackets includes a third orthodontic bracket for installation on the left side of the oral cavity on the first row of teeth and a fourth orthodontic bracket for installation on the right side of the oral cavity on a second row of teeth, the third orthodontic bracket and the fourth orthodontic bracket being substantially identical.

14. The orthodontic appliance of claim 13, wherein the third orthodontic bracket and the fourth orthodontic bracket are cuspid brackets.

15. The orthodontic appliance of claim 1, wherein the archwire has a rectangular cross-section with rounded corners.

16. An orthodontic bracket comprising:
a bracket base for bonding the orthodontic bracket to a respective tooth; and
a bracket body extending from the bracket base, the bracket body defining an archwire slot having 0.020-inch slot height and 0.026-inch slot depth and adapted to retain an archwire having a 0.019-inch wire height and a 0.025-inch wire depth; and
wherein the orthodontic bracket is installable according to a prescription on either a left side of an oral cavity or a right side of the oral cavity on a same row of teeth.

17. The orthodontic bracket of claim 16, wherein the orthodontic bracket has a total torsional play of less than twenty-six degrees.

18. The orthodontic bracket of claim 16, wherein the orthodontic bracket comprises a ligating slide movable from an open position to a closed position to retain the archwire in the archwire slot, the ligating slide comprising a front surface, a rear surface, and a leading edge having a curved wire pushing portion.

19. The orthodontic bracket of claim 16, wherein the bracket body comprises:
a mesial gingival tie wing;
a distal gingival tie wing;
a gingival wall extending between the mesial gingival tie wing the distal gingival tie wing; and
a universal gingival hook extending from the gingival wall between the mesial gingival tie wing and the distal gingival tie wing.

20. A method comprising:
providing an orthodontic appliance that comprises a plurality of orthodontic brackets, each orthodontic bracket of the plurality of orthodontic brackets comprising:
a bracket base for bonding the orthodontic bracket to a respective tooth; and
a bracket body extending from the bracket base, the bracket body defining an archwire slot having 0.020-inch slot height and 0.026-inch slot depth and adapted to retain an archwire having a 0.019-inch wire height and a 0.025-inch wire depth, wherein the plurality of orthodontic brackets includes a first orthodontic bracket and second orthodontic bracket, the first orthodontic bracket installable according to a prescription on either a left side of an oral cavity of a patient or a right side of the oral cavity of the patient on a first row of teeth, the second orthodontic bracket being substantially identical to the first orthodontic bracket; and
installing the orthodontic appliance in the oral cavity of the patient.
